(19) United States
(12) Patent Application Publication
(10) Pub. No.: US 2011/0273740 A1
(43) Pub. Date: Nov. 10, 2011

(54) PREVIEW SCREEN DISPLAY CONTROL APPARATUS AND PREVIEW SCREEN DISPLAY CONTROL PROGRAM

(75) Inventors: Hong YANG, Ibaraki-ken (JP); Kouichi NOBUSHIMA, Ibaraki-ken (JP); Asuka ARAKI, Ibaraki-ken (JP)

(73) Assignee: RISO KAGAKU CORPORATION, Tokyo (JP)

(21) Appl. No.: 12/979,930

(22) Filed: Dec. 28, 2010

(30) Foreign Application Priority Data
May 7, 2010 (JP) 106907/2010

(51) Int. Cl. G06F 3/12

(52) U.S. Cl. 358/1.15

(57) ABSTRACT

A preview screen display control apparatus includes: a print data generating section that receives image data and generates print data which is capable of being discriminated by a printing apparatus, based on the image data; a print data transmitting section that communicates with the printing apparatus, receives the print data output from the print data generating section, and outputs the print data to the printing apparatus; and a preview screen display control section that displays a preview screen based on the print data generated by the print data generating section. The print data transmitting section is configured to output a control signal that causes the preview screen display control section to initiate operations, and the preview screen display control section is configured to initiate operations based on the control signal output by the print data transmitting section to display the preview screen.

### BACKGROUND OF THE INVENTION

1. Field of the Invention

The present invention is related to a preview image display control apparatus and a preview screen display control program that cause preview screens to be displayed, based on input image data.

2. Description of the Related Art

There are known conventional techniques, for displaying images of actual prints as previews prior to printing, when image data generated by editing applications such as notepad and MS Word™ are printed (refer to Japanese Unexamined Patent Publication Nos. 2003-167721 and 2004-102618, for example).

Here, a conventional printer system equipped with a preview application that causes the aforementioned images of prints to be displayed as preview screens will be described with reference to FIG. 3.

A conventional printer system is equipped with a computer 100, a printer 200 which is connected to the computer 100 and a monitor 300, as illustrated in FIG. 3. The computer 100 is provided with an application 110, a Windows GDI 120, a print processor 130, a spooler 140, a printer driver 150, a language monitor 160, an output port 170, and a preview application 190.

In the printer system of FIG. 3, first, a set of image data is generated by editing text, drawings, and photographic images using the application 110. When a print command is selected within the application 110, a user interface 151 of the printer driver 150 is booted up and a print condition reception screen, for receiving input of various printing conditions, output methods, and requests to display preview screens, is displayed.

The various printing conditions, output methods, and requests to display preview screens are set by a user in the print condition reception screen. At this time, the Windows GDI 120 generates EMF (Enhanced Meta File) data based on the input image data and printing conditions, and the EMF data is temporarily stored in the spooler 140, in the case that a request to display preview screens is selected.

After the EMF data is stored in the spooler 140, the print processor 130 outputs a control signal to execute the preview application 190, and the preview application 190 is executed. The print processor 130 reads out the EMF data from the spooler 140 in units of pages, obtains the EMF data for each page via the Windows GDI 120, and outputs the obtained EMF data to the preview application 190.

The preview application 190 employs the input EMF data to cause preview screens to be displayed on the monitor 300.

If a final print command is received in the preview screen, the print processor causes the EMF data to be output from the spooler 140 to a graphics driver 152 via the Windows GDI 120.

The graphics driver 152 generates print data which is compatible with the printer 200 based on the input EMF data, and outputs the print data to the language monitor 160.

The language monitor communicates with the printer 200 that corresponds to the printer driver 150, and outputs the print data to the printer 200 via the output port corresponding thereto. The printer performs printing processes based on the input print data.

In the conventional printer system as described above, the print processor 130 executes the preview application 190 and causes the preview screen to be displayed. However, in the case that the printer 200 is not physically connected to the computer 100, or in the case that the printer 200 is turned OFF, a system error occurs, and the print processor 130 cannot operate normally thereafter. That is, the preview application 190 cannot be executed, and the preview screen cannot be displayed.

There are cases in which it is desired to confirm a print image even when the printer 200 is not physically connected to the computer 100 or the printer 200 is turned OFF as described above, that is, when a print is not to be output. However, conventional printer systems cannot enable confirmation in these cases.

Similarly, in cases the computer 100 is not provided with a connection port, but only with an output port of the printer driver 150, an error will occur, the print processor 130 will cease to function properly, and the preview application 190 cannot be executed. This will also result in not being able to confirm an image to be printed by a printer corresponding to the printer driver 150.

Further, in the case that a printing condition “transmit print data directly to printer” is selected in a printing condition input screen of the printer driver 150 of a conventional printer system as illustrated in FIG. 4, the EMF data are not generated. In this case, the Windows GDI 120 directly outputs image data and printing conditions to the graphics driver 152, the graphics driver 152 generates print data based on the image data and printing conditions, and the language monitor 160 outputs the print data to the printer 200. Therefore, the print processor 130 does not initiate operations and the preview application 190 is not executed in this case as well. As a result, a preview screen cannot be displayed.

In addition, in the case that printing conditions “spool print document to accelerate program printing processes” and “immediately transmit print data to printer” are selected and a printing condition “enable detailed printing functions” is not selected as illustrated in FIG. 5, operations of the print processor 130 are initiated. However, because the printing condition “enable detailed printing functions” is not selected, the print processor 130 is not enabled to obtain detailed printing conditions which are set by the user interface 151 of the printer driver 150. Accordingly, the aforementioned EMF data are not generated, and the preview application 190 cannot be executed.

In addition, in the case that file output is selected in a print reception screen of a conventional application 110, the EMF data are not generated. In this case, the Windows GDI 120 directly outputs image data and printing conditions to the graphics driver 152, the graphics driver 152 generates print data based on the image data and printing conditions, and the print data is saved. The print processor 130 does not initiate operations, and the preview application 190 is not executed, and therefore, a preview screen cannot be displayed.

In the conventional printer system described above, preview screens are displayed using EMF data generated by the Windows GDI 120. However, the EMF data and the print data which is generated by the printer driver 150 and actually output to the printer 200 do not necessarily match. Therefore, an accurate print image cannot be displayed as the preview screen.

Specifically, when the EMF data are input to the graphics driver 152 via the windows GDI 120, there are cases in which the data are converted to match the performance capabilities of the graphic driver 152. Therefore, there are cases in which print data (RAW data) generated by the graphics driver 152 and print data obtained by directly processing the EMF data differ. In these cases, print images canot be accurately represented in a preview screen.

### SUMMARY OF THE INVENTION

The present invention has been developed in view of the foregoing circumstances. It is an object of the present invention to provide a preview screen display control apparatus and a preview screen display control program which are capable of displaying preview screens in cases that the operations of a print processor are not initiated or in cases that communications between a computer and a printer are not possible, and also capable of displaying preview screens that accurately represent print images which are actually printed.

A preview screen display control apparatus of the present invention comprises:

a print data generating section that receives image data and generates print data which is capable of being discriminated by a printing apparatus, based on the image data;

a print data transmitting section that communicates with the printing apparatus, receives the print data output from the print data generating section, and outputs the print data to the printing apparatus; and

a preview screen display control section that displays a preview screen based on the print data generated by the print data generating section; and is characterized by:

the print data transmitting section being configured to output a control signal that causes the preview screen display control section to initiate operations; and

the preview screen display control section being configured to initiate operations based on the control signal output by the print data transmitting section to display the preview screen.

In the preview screen display control apparatus of the present invention, a configuration may be adopted, wherein the print data transmitting section outputs the control signal to the preview screen display control section even in a state in which communications with the printing apparatus is not possible.

In the preview screen display control apparatus of the present invention, a configuration may be adopted, wherein the preview screen display control section is configured to initiates operations solely based on the control signal output from the print data transmitting section.

The preview screen display control apparatus of the present invention may further comprise:

a print data storing section, for temporarily storing the print data output from the print data transmitting section.

A preview screen display control program of the present invention causes a computer to function as:

a print data generating section that receives image data and generates print data which is capable of being discriminated by a printing apparatus, based on the image data;

a print data transmitting section that communicates with the printing apparatus, receives the print data output from the print data generating section, and outputs the print data to the printing apparatus; and

a preview screen display control section that displays a preview screen based on the print data generated by the print data generating section; and is characterized by:

the print data transmitting section being configured to output a control signal that causes the preview screen display control section to initiate operations; and

the preview screen display control section being configured to initiate operations based on the control signal output by the print data transmitting section to display the preview screen.

The preview screen display control apparatus and the preview screen display control program of the present invention are equipped with: the print data generating section that receives image data and generates print data which is capable of being discriminated by a printing apparatus, based on the image data; the print data transmitting section that communicates with the printing apparatus, receives the print data output from the print data generating section, and outputs the print data to the printing apparatus. The print data transmitting section is configured to output a control signal that causes the preview screen display control section to initiate operations, and the preview screen display control section is configured to initiate operations based on the control signal output by the print data transmitting section to display the preview screen, which is based on the print data generated by the print data generating section. Therefore, the preview screen can be displayed even in cases that a print processor does not operate properly or does not initiate operations. In addition, a preview screen that accurately represents the print image which is to be actually printed can be displayed.

In addition, a configuration may be adopted, wherein the print data transmitting section is configured to output the control signal to the preview screen display control section even when communications with the printing apparatus are not possible. In this case, preview screens can be displayed even in cases that the printing apparatus is not physically connected to the preview screen display control apparatus, and in cases that the printing apparatus is turned OFF.

Note that as described above, a conventional print processor cannot operate properly in cases that the printing apparatus is not physically connected, and in cases that the printing apparatus is turned OFF, and therefore preview display of print data is not possible.

### BRIEF DESCRIPTION OF THE DRAWINGS

FIG. 1 is a block diagram that illustrates the schematic construction of a printer system that employs an embodiment of the preview screen display control apparatus of the present invention.

FIG. 2 is a flow chart that illustrates the steps of a process performed by the embodiment of the preview screen display control apparatus of the present invention.

FIG. 3 is a block diagram that illustrates the schematic construction of a conventional printer system.

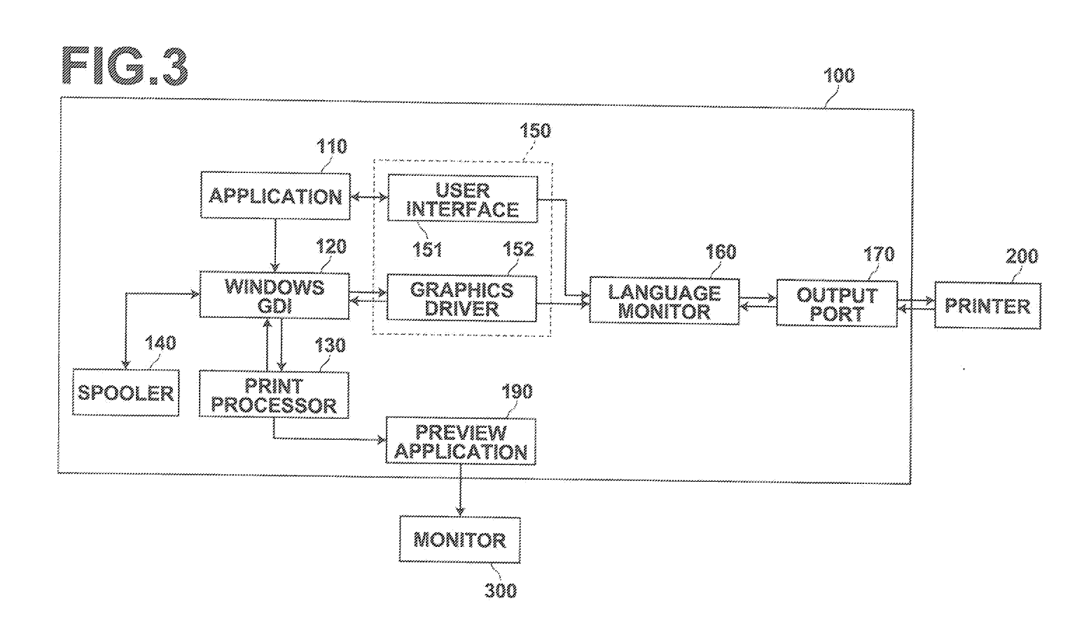

FIG. 4 is a diagram that illustrates an example of a printing condition input screen which is displayed by a printer driver of the conventional printer system.

FIG. 5 is a diagram that illustrates another example of a printing condition input screen which is displayed by the printer driver of the conventional printer system.

### DESCRIPTION OF THE PREFERRED EMBODIMENTS

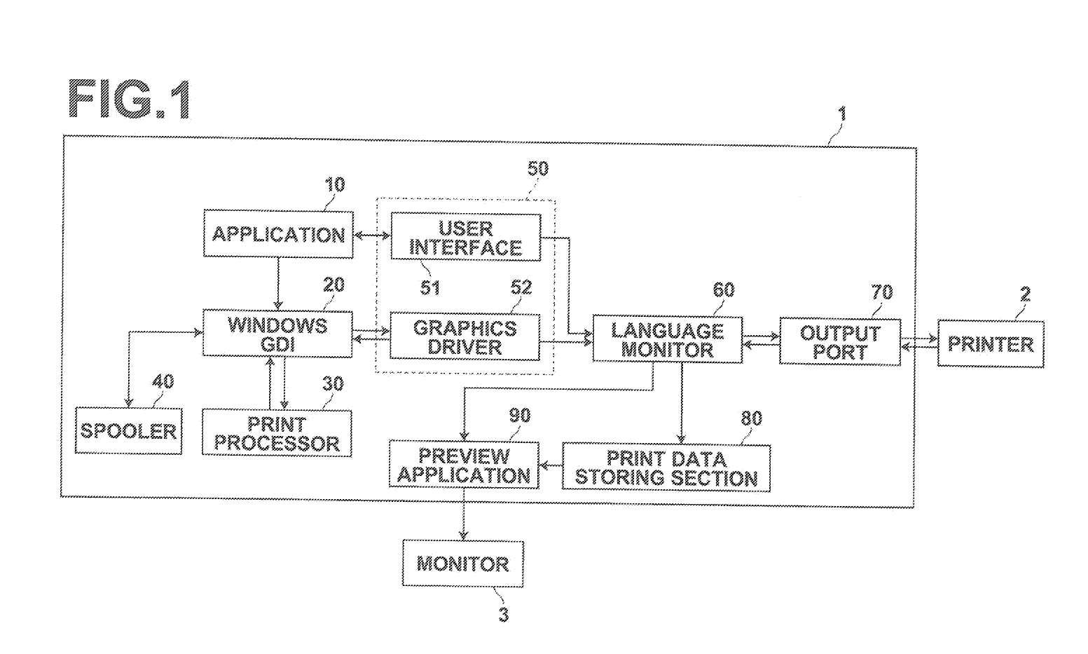

Hereinafter, a printer system that employs an embodiment of the preview screen display control apparatus and the preview screen display control program of the present invention will be described with reference to the attached drawings. FIG. 1 is a diagram that schematically illustrates the entire construction of the printer system of the embodiment.

The printer system of the present embodiment is equipped with: a computer 1; a printer 2, which is connected to the computer 1 via a physical connection or via a network such as a wireless LAN; and a monitor 3, which is connected to the computer 1.

The computer 1 is equipped with: an application 10; a Windows GDI 20; a print processor 30; a spooler 40; a printer driver 150; a language monitor 60; an output port 70; a print data storing section 80; and a preview application 90.

Note that the application 10, the Windows GDI 20, the print processor 30, the spooler 40, the printer driver 50, the language monitor 60, and the output port 70 are constituted by programs which are installed on the computer 1. The print data storing section 80 is constituted by memory, such as RAM, or by hardware, such as a hard disk.

The application 10 is a program for editing image data that represent document images, such as Notepad and Microsoft Word™. The image data which is edited by the application 10 is output to the Windows GDI 20.

The Windows GDI 20 is provided by Microsoft Windows™, which is installed in the computer 1 as an operating system (hereinafter, referred to as “OS”). The Windows GDI 20 receives the image data output by the application 10 and printing conditions, generates EMF (Enhanced Meta File) data based on the image data and the printing conditions, and temporarily stores the EMF data in the spooler 40. Alternatively, the Windows GDI 20 outputs the image data output by the application 10 and the printing conditions directly to the printer driver 50 without generating the EMF data, according to commands from the printer driver 50.

The print processor 30 reads the EMF data from the spooler 40 in units of pages, based on print commands output from the application 10. Then, the print processor outputs EMF data corresponding to each page to a graphics driver 52 of the printer driver 50 via the Windows GDI 20. The print processor 30 may be that which is prepared as a module of the OS, or may be that which is customized according to the type of the printer 2.

The spooler 40 stores EMF data, generated based on the image data output by the application 10 and the printing conditions, in a print cue for each print job. Then, the spooler 40 sequentially outputs EMF data for each print job according to requests from the print processor 30.

The printer driver 50 is equipped with: a user interface 51 that receives operator input of various printing conditions, such as the number of pages to be printed, the number of copies to be printed, and imposition, output methods, and requests to display preview screen; and the graphics driver 52 that generates and outputs print data which is capable of being discriminated by the printer 2, based on data output from the Windows GDI 20. PDL (Page Description Language) data and raster data are examples of print data which are generated by the graphics driver 52. Note that the printer driver 50 corresponds to the print data generating section recited in the claims.

In the case that preview display is not requested, the language monitor 60 communicates with the printer 2, and outputs the print data output from the graphics driver 52 of the printer driver 50 to the printer 2 via the output port. In the case that preview display is requested, the language monitor outputs the print data to the print data storing section 80, without outputting the print data to the output port. Note that the language monitor 60 corresponds to the print data transmitting section recited in the claims.

In addition, the language monitor 60 of the present embodiment outputs a control signal that causes the preview application 90 to be executed, in response to a request to display a preview screen output from a user interface 51 of the printer driver 50.

The language monitor 60 is capable of outputting the control signal to the preview application 90 in cases that the printer 2 is not physically connected to the computer 1, and cases that the printer 2 and the computer 1 are physically connected, but the printer 2 is turned OFF, for example.

The preview application 90 is executed in response to the control signal output from the language monitor 60. The preview application 90 generates a display control signal based on the print data output from the print data storing section 80, and outputs the display control signal to the monitor 3. Note that the preview application 90 corresponds to the preview screen display control section recited in the claims.

In the present embodiment, the preview application 90 generates the display control signal using the print data output from the print data storing section 80. However, the present invention is not limited to this configuration. For example, the print data output by the language monitor 60 may be directly input to the preview application 90, and the preview application 90 may generate the display control signal based on the directly input print data. Note that the preview application 90 of the present embodiment is executed only in response to the control signal output from the language monitor 60.

A stencil printer, an ink jet printer, a laser printer, etc. may be employed as the printer 2. Note that the printer 2 connected to the computer 1 is not limited to a single printer, and a plurality of printers 2 may be connected to the computer 1.

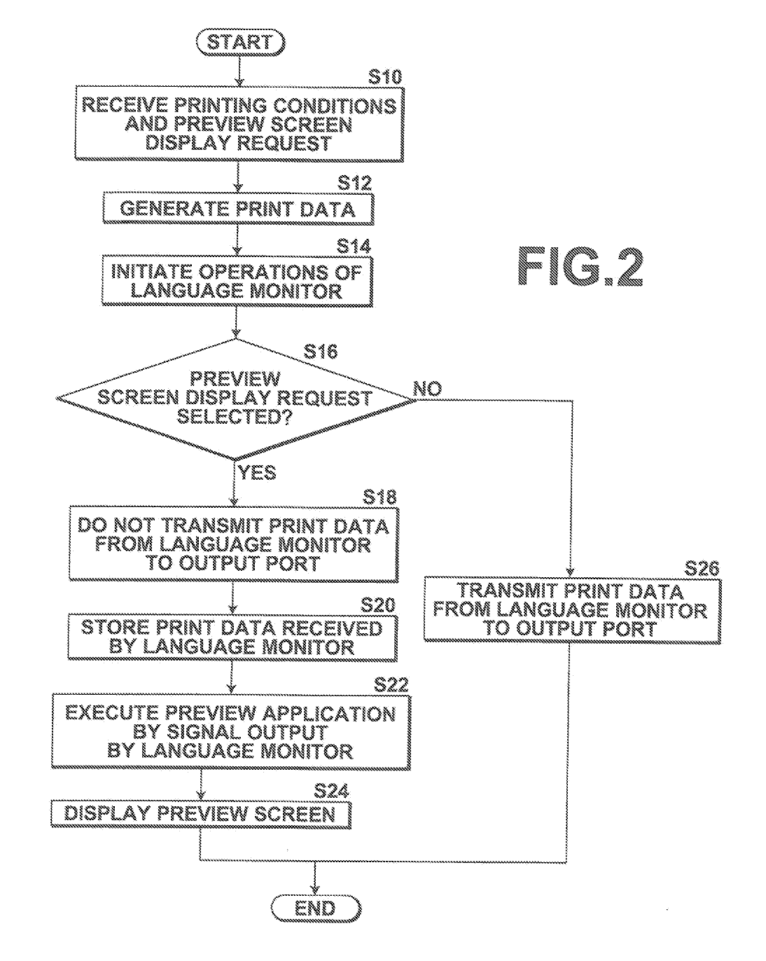

Next, the operation of the printer system of the present embodiment will be described with reference to the flow chart of FIG. 2.

First, the application 10 is executed, and the application 10 is employed to edit text, illustrations, photographic images, and the like, to generate image data. Then, when a print command is selected in the application 10, the user interface 51 of the printer driver 51 is booted up, and a printing condition input screen, for receiving input of various printing conditions, output methods, and requests for preview screen display, is displayed.

The various printing conditions, the output method, and the request for preview screen display are set by an operator in the printing condition input screen (step S10). In the case that a preview display command is selected in the printing condition input screen, image data is output from the application 10, then input to the graphics driver 52 via the Windows GDI 20. The graphics driver 52 converts the input image data to print data which can be discriminated by the printer 2, then outputs the print data (RAW data) to the language monitor (step S12).

In the case that the preview display command is selected in the printing condition input screen, the operations of the language monitor 60 are initiated along with the generation of the print data described above (step S14).

Then, whether the preview screen display request has been selected in the printing condition input screen is confirmed (step S16). In the case that the preview screen display request has been selected (step S16: YES), the language monitor 60 ceases transmission of the input print data to the output port, and stores the print data in the print data storing section 80 (step S18, step S20).

Further, the language monitor 60 outputs the control signal that causes the preview application 90 to be executed, and the preview application 90 is executed in response to the control signal input thereto (step S22).

Then, the preview application 90 reads out the print data stored in the print data storing section 80, and causes a preview screen that represents a print image to be displayed on the monitor 3, based on the read out print data (step S24). Thereafter, if a print command is ultimately selected, the printer 2 performs a printing process based on the input print data as necessary.

Meanwhile, in the case that it is confirmed that the preview screen display request has not been selected at step S16 (step S16: NO), the language monitor 60 communicates with the printer 2 corresponding to the printer driver 50, and outputs the print data to the printer 2 via the output port 70 corresponding to the printer 2 (step S26). Thereafter, if a print command is ultimately selected, the printer 2 performs a printing process based on the input print data. In the case that the printer 2 is not connected to the computer 1 or the like, an error message is displayed or the like.

According to the printer system of the embodiment described above, the language monitor 60 outputs the control signal that causes the preview application 90 to be executed in the case that the preview screen display request is selected. The preview application 90 is executed based on the control signal output by the language monitor 60, and the preview screen is displayed based on the print data generated by the printer driver 50. Therefore, the preview screen can be displayed in cases that the print processor 30 is not functioning properly or at all. In addition, the preview screen is that which accurately represents the print image which will actually be printed.

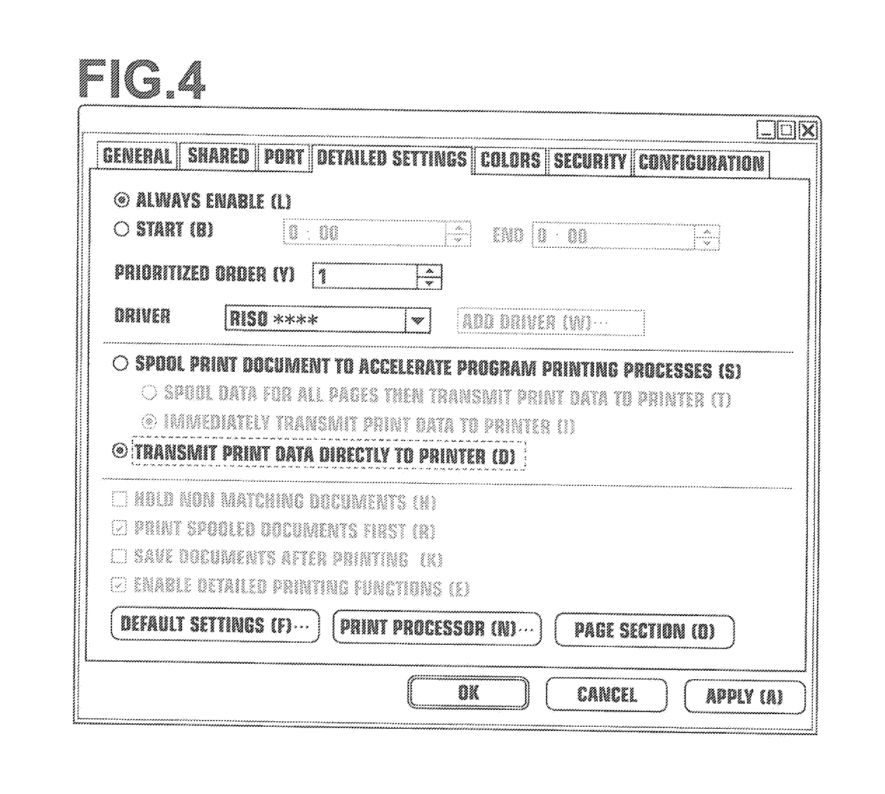

In conventional printer systems, in the case that the condition “transmit print data directly to printer” is selected in the printing condition input screen as illustrated in FIG. 4, the operations of the print processor are not initiated as described above, and the preview application is not executed, resulting in the preview screen not being able to be displayed. However, according to the printer system of the embodiment described above, the language monitor 60 causes the preview application 90 to be executed in the case that a preview screen display request is selected, and therefore the preview screen can be displayed appropriately, even if the condition “transmit print data directly to printer” is selected in the printing condition input screen.

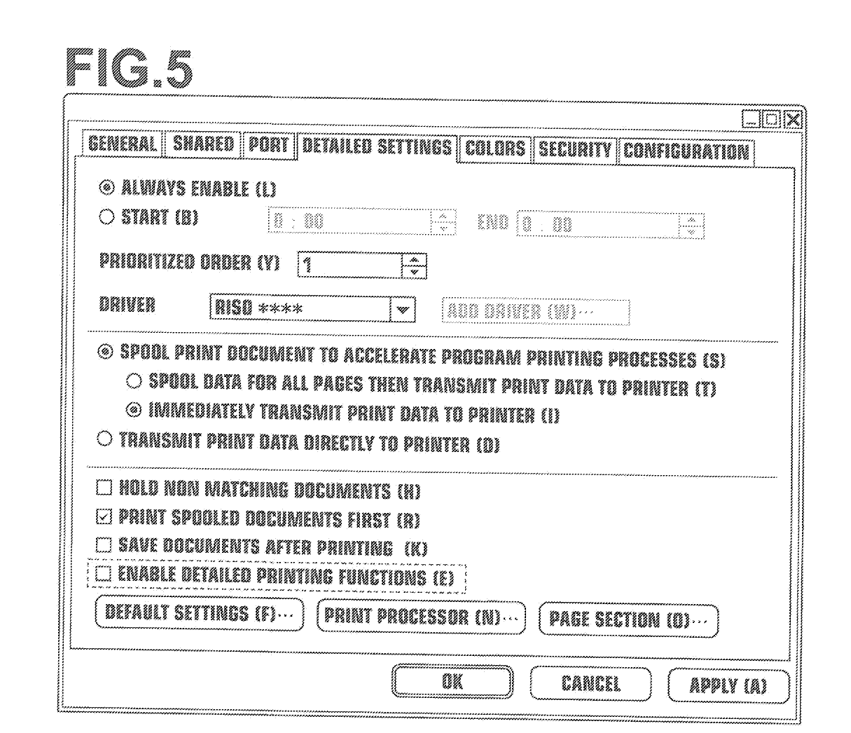

In addition, in conventional printer systems, in the case that printing conditions “spool document to be printed to perform program printing processes in an accelerated manner” and “immediately transmit print data to printer” are selected and a printing condition “enable detailed printing functions” is not selected as illustrated in FIG. 5, operations of the print processor are initiated, but EMF data are not generated, and the preview application cannot be executed. In contrast, in the printer system of the embodiment described above, the language monitor 60 causes the preview application 90 to be executed in the case that a preview screen display request is selected, and therefore the preview screen can be displayed appropriately regardless of whether EMF data are generated.

Further, in conventional printer systems, in the case that file output is selected, EMF data are not generated. In this case, operations of the print processor are not initiated, the preview application is not executed, and therefore, a preview screen cannot be displayed. In contrast, in the printer system of the embodiment described above, the language monitor 60 causes the preview application 90 to be executed in the case that a preview screen display request is selected, and therefore the preview screen can be displayed appropriately regardless of whether EMF data are generated or whether operations of the print processor are initiated.

Note that in the printer system of the embodiment described above, in the case that file output is selected, print data may be generated by the graphics driver 52 based on input image data and printing conditions. Then, the print data may be stored in the print data storing section 80.

In this case as well, if the preview screen display request is selected, the language monitor 60 may execute the preview application. Then, the preview application may cause a preview screen that represents a print image to be displayed on the monitor 3, based on the print data which are read out from the print data storing section 80.

Note that in the embodiment described above, the preview application 90 is that which has a function of displaying preview screens. The preview application 90 may further have the function of editing the print data. For example, the preview application 90 may be enabled to change assignments of colors and the manner of imposition.

Note that in the embodiment described above, the print data (RAW data) are generated without generating EMF data or without initiating the operations of the print processor 30, and the preview application 90 is executed by the language monitor 60 to display the preview screen. Alternatively, the Windows GDI 20 may generate EMF data, the operations of the print processor 30 may be initiated, the graphics driver 52 may convert the EMF data to print data (RAW data), then the preview application 90 may be executed by the language monitor 60 to display a preview screen, for example. In this case, the amount of time that the application 10 is consumed by preview processes and printing processes of a print job can be shortened.

In the conventional printer system described above, preview screens are displayed using EMF data generated by the Windows GDI 120. However, the EMF data and the print data which is generated by the printer driver 150 and actually output to the printer 200 do not necessarily match. Therefore, an accurate print image cannot be displayed as the preview screen.

Specifically, when the EMF data are input to the graphics driver 152 via the windows GDI 120, there are cases in which the data are converted to match the performance capabilities of the graphic driver 152. Therefore, there are cases in which print data (RAW data) generated by the graphics driver 152 and print data obtained by directly processing the EMF data differ. In these cases, print images canot be accurately represented in a preview screen.

What is claimed is:

1. A preview screen display control apparatus, comprising:
a print data generating section that receives image data and generates print data which is capable of being discriminated by a printing apparatus, based on the image data;
a print data transmitting section that communicates with the printing apparatus, receives the print data output from the print data generating section, and outputs the print data to the printing apparatus; and
a preview screen display control section that displays a preview screen based on the print data generated by the print data generating section;
the print data transmitting section being configured to output a control signal that causes the preview screen display control section to initiate operations; and
the preview screen display control section being configured to initiate operations based on the control signal output by the print data transmitting section to display the preview screen.

2. A preview screen display control apparatus as defined in claim 1, wherein:
the print data transmitting section outputs the control signal to the preview screen display control section even in a state in which communications with the printing apparatus is not possible.

3. A preview screen display control apparatus as defined in claim 1, wherein:
the preview screen display control section is configured to initiates operations solely based on the control signal output from the print data transmitting section.

4. A preview screen display control apparatus as defined in claim 1 further comprising:
a print data storing section, for temporarily storing the print data output from the print data transmitting section.

5. A non transitory computer readable recording medium, having a preview screen display control program stored therein that causes a computer to function as:
a print data generating section that receives image data and generates print data which is capable of being discriminated by a printing apparatus, based on the image data;
a print data transmitting section that communicates with the printing apparatus, receives the print data output from the print data generating section, and outputs the print data to the printing apparatus; and
a preview screen display control section that displays a preview screen based on the print data generated by the print data generating section;
the print data transmitting section being configured to output a control signal that causes the preview screen display control section to initiate operations; and
the preview screen display control section being configured to initiate operations based on the control signal output by the print data transmitting section to display the preview screen.
